(19) United States
(12) Patent Application Publication
(10) Pub. No.: US 2013/0264436 A1
(43) Pub. Date: Oct. 10, 2013

(54) ARTICULATED ARM IN PARTICULAR FOR AN ELECTRICAL APPLIANCE AND INSTALLATION FOR AN ELECTRICAL APPLIANCE

(71) Applicant: MAQUET SAS, Ardon (FR)

(72) Inventors: Patrice Changeux, Guilly (FR); Laurent Brillant, Neung Sur Beuvron (FR)

(73) Assignee: MAQUET SAS, Ardon (FR)

(21) Appl. No.: 13/859,249

(22) Filed: Apr. 9, 2013

(30) Foreign Application Priority Data
Apr. 10, 2012 (FR) 12 53260

(51) Int. Cl. F16M 13/02; F16L 3/015

(52) U.S. Cl. CPC F16M 13/022; F16L 3/015
USPC 248/70

(57) ABSTRACT

An articulated arm comprises first and second coplanar members comprising first and second toothed portions meshed with one another and separated by an intermediate piece to which each member is connected by a first, second pivot connection from first, second axes, the intermediate piece being monobloc and having a central body integral with a first and a second shaft defining the first and second axes, the first and second shafts being separated by an opening through the central body and able to allow the passage of a cable kept away from the first and second toothed portions by the closed outline of the opening.

### CROSS-REFERENCE TO RELATED APPLICATION

This application claims priority under 35 USC §119 to French Patent Application No. 12 53260 filed on Apr. 10, 2012, which application is hereby incorporated by reference in its entirety.

### TECHNICAL FIELD

The invention relates to an articulated arm in particular for an electrical appliance, comprising at least first and second coplanar members separated by an intermediate piece to which each member is connected respectively by means of a first and a second pivot connection allowing their relative swiveling about first and second axes parallel to one another, the first and second members comprising respectively first and second circular toothed portions able to swivel about the first and second axes and arranged so as to mesh with one another.

The invention also relates to an installation for an electrical appliance comprising a support supporting at least one articulated arm whose free end is provided with an electrical appliance, in particular a lighting equipment electrically supplied by a cable.

### PRIOR ART

This type of articulated arm is intended for example to be used to suspend an electrical appliance equipping a medical operating room. This articulated arm is generally associated with other articulated arms, each of them supporting another electrical appliance. These electrical appliances can weigh up to several tens of kilograms. Also, for the medical staff, it is important to be able to move the electrical appliances, easily and precisely in space towards various positions. These articulated arms are generally designed to allow combined vertical and horizontal displacements. For this purpose, each articulated arm can comprise an extension arm intended to swivel in a horizontal plane with respect to a fixed support, and a compensation arm coupled with the extension arm and intended to swivel in a vertical plane with respect to the extension arm. The free end of the compensation arm supports the electrical appliance which, thanks to the combined swiveling of the extension and compensation arms, can thus be moved and positioned in space. The compensation arm is for example coupled with the extension arm by means of a pivot connection. In order to allow the compensation arm to move over 360° with respect to the extension arm, it is thus necessary to arrange the ends of the extension arm and the compensation arm, connected together by means of a pivot connection, in different horizontal planes. Such an articulated arm, one example of which is in particular presented in publication DE 196 53 507, is thus cumbersome in height and can hamper the medical staff. Moreover, the pivot connection of this articulated arm comprises a rotating contactor ensuring the power supply of the electrical appliance supported by the articulated arm. However, this technology is expensive, in particular when it is necessary to transmit at least one electrical supply current (power supply) and at least two distinct signals which can be at a high frequency of about some Giga Hertz, which is the case for some electrical appliances used in operating rooms.

From publication GB 460,441 it is also known an articulated arm comprising first and second coplanar members separated by two upper plates and by two lower plates provided in horizontal planes, the upper plates being arranged opposite the lower plates. Each upper plate is coupled with the first and second members by means of two bolts, one bolt for each first, second member. In the same way, each lower plate is coupled with the first and second arms by means of two bolts, one bolt for each first, second member. Thus, the couple of bolts associated with the first member define a first pivot connection and the couple of bolts associated with the second member define a second pivot connection. The articulated arm thus comprises two pivot connections between which extends an electric cable for an electrical appliance supported at the end of the articulated arm. The first and second members of the articulated arm moreover comprise circular toothed portions, coaxial with the pivot connection and meshing with one another. Like the preceding articulated arm, this articulated arm also can move over 360°, but here while maintaining the first and second members in the same horizontal plane. The overall height of the articulated arm is thus limited. However, when the first and second members swivel, there are an important risk that the cable becomes wedged, which is detrimental to the reliability of the power supply during the surgical operation.

At last, publication WO 2008/112 687 is known which describes an articulated arm whose both members are connected by a monobloc piece supported by shafts to which they are connected so as to form a pivot connection.

### DISCLOSURE OF THE INVENTION

The purpose of the invention is to propose another articulated arm able to move over 360°, having a simple and robust design and a limited overall height, avoiding the risk that the cable becomes wedged and thus guaranteeing a supply of energy, for example of electric energy, and/or a reliable transmission of signals.

For this purpose, the object of the invention is an articulated arm in particular for an electrical appliance, comprising at least first and second coplanar members separated by an intermediate piece to which each member is connected respectively by means of a first and a second pivot connection allowing their relative swiveling about first, second axes parallel to one another, the first and second members respectively comprising first and second circular toothed portions able to swivel about the first and second axes and arranged to mesh with one another, the articulated arm comprising a cable extending from the first member to the second member up to the electrical appliance, wherein the intermediate piece is monobloc and comprises a central body integral with a first and a second shaft defining the first and second axes, the first and second shafts being separated by a closed-outline opening through the central body, in that the cable extends through the opening in the monobloc intermediate piece so that the cable is kept away from the first and second toothed portions by the closed outline of the opening. The cable is for example an electric supply cable or a signal transmission cable, for example for “high frequency” signals such as video HD signals, data-processing signals. The idea of the invention is to provide a monobloc intermediate piece provided therethrough with a closed-outline opening so as to make sure in any configuration that the cable is not in contact with the toothed portions. The articulated arm according to the invention enables to use a power supply and/or a more reliable transmission of signals through a cable than through rotating contactors.

The articulated arm according to the invention can advantageously present the following features:

the opening has an oblong shape whose length is oriented from the first to the second axis, perpendicularly to the first and second axes;

the center distance between the first and second axes is at least equal to the sum of the half-widths of the first and second members in order to allow the swiveling of the second member with respect to the first member between two extreme positions separated by an angle of 360°;

each first, second member comprises respectively a pair of first and second female bearings, cylindrical and coaxial with one another, the ends of the first and second shafts being arranged so as to project on both sides of the central body and to define respectively first and second male bearings, cylindrical and coaxial with one another and able to cooperate with the female bearings so as to define the first and second axes;

the first toothed portion comprises one of the first female bearings and the second toothed portion comprises one of the second female bearings;

the articulated arm comprises first and second rolling elements provided between each first, second male bearing and the corresponding first, second female cylindrical bearing;

the articulated arm comprises a first protective housing integral with the first member and a second protective housing integral with the second housing, each first, second housing being arranged so as to surround the first, second rolling elements and to keep them away from the outside of the articulated arm;

the articulated arm comprises a central protective housing integral with the intermediate piece and arranged to surround the first and second toothed portions and to keep them away from the outside of the articulated arm;

the articulated arm comprises friction means provided between the intermediate piece and at least one of the first and second members, arranged so as to slow down the swiveling of the first and second members, respectively, with respect to the intermediate piece in order to make it fluid and regular.

The invention extends to an installation for an electrical appliance comprising a support supporting at least one articulated arm whose free end is provided with an electrical appliance, in particular a lighting equipment connected by a cable, wherein it comprises an articulated arm as described above.

### BRIEF DESCRIPTION OF THE DRAWINGS

The present invention will be better understood and other advantages will emerge from the detailed description of an embodiment given as a nonrestrictive example and illustrated in the annexed drawings, in which:

FIG. 1 is a sectional view of a part of the articulated arm according to the invention in particular illustrating the first member used as an extension arm, the second member and the intermediate piece;

FIG. 2 is a perspective view of a part of the articulated arm in FIG. 1 comprising a third member used as a compensation arm;

FIG. 3 is a front view of the intermediate piece of the articulated arm in FIGS. 1 and 2;

FIG. 4 is a top view of a part of the articulated arm in FIGS. 1 and 2 illustrating the circular toothed portions of the first and second members;

FIG. 5 is a schematic top view of an installation for an electrical appliance comprising several articulated arms, one of these articulated arms being represented with its first and second members in various positions in the same horizontal plane.

### DESCRIPTION OF THE EMBODIMENTS OF THE INVENTION

In a nonrestrictive way, the articulated arm according to the invention is intended for example to be fixed to a support suspended from the ceiling of an operating room in order to support an electrical appliance such as for example a lighting equipment, a camera, a flat screen support, a monitor or any other adapted equipment.

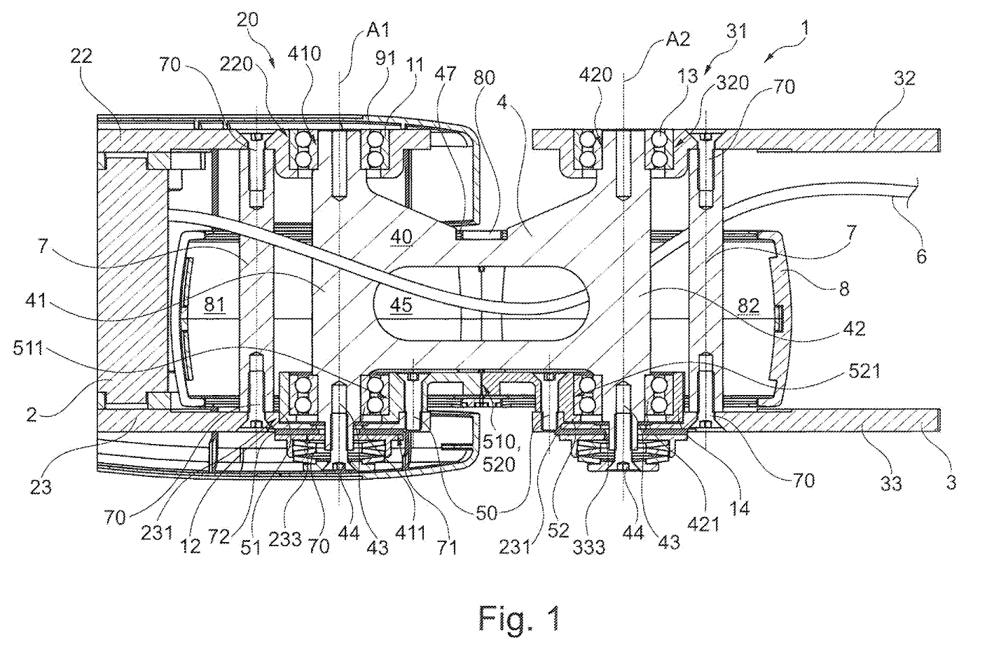

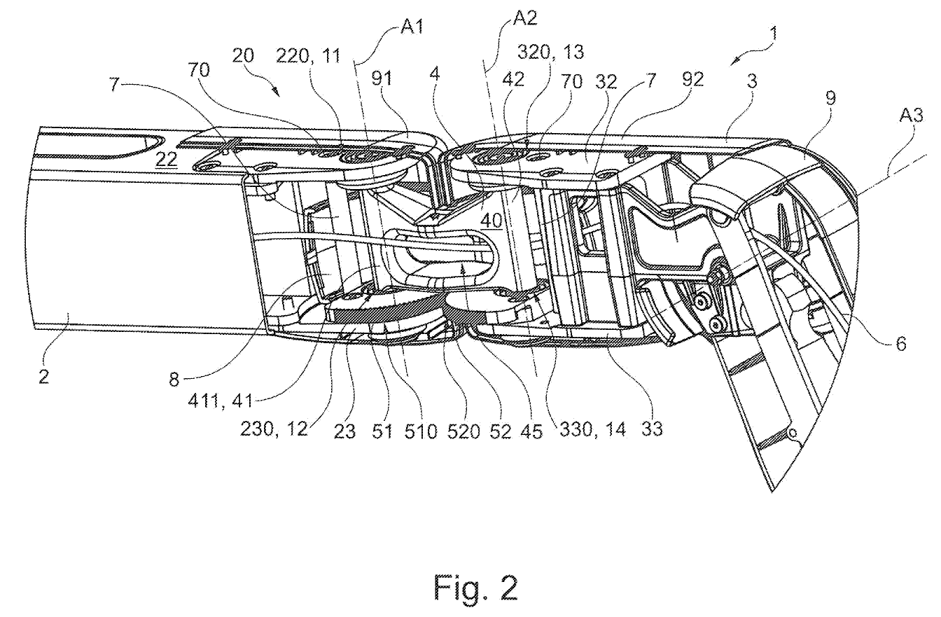

In reference to FIGS. 1 and 2, the articulated arm 1 comprises a first member 2 and a second member 3, coplanar and separated by an intermediate piece 4. A first end 20 of the first member 2 (represented in FIG. 5) is intended to be fixed for example to a vertical support 5 (schematically represented in FIG. 5) suspended from the ceiling of the operating room and able to receive the first ends 20 of several first members 2. The fixation of the first end 20 of the first member 2 to the support 5 is generally carried out so that the first member 2 is substantially horizontal. The first member 2 can be designed so as to be able swivel with respect to the support 5 via a pivot connection (not represented). The second end 21 of the first member 2 is coupled with the intermediate piece 4 by means of a first pivot connection allowing the relative swiveling of the first member 2 and the intermediate piece 4 about a first vertical axis A1. A first end 30 (represented in FIG. 5) of the second member 3 supports the electrical appliance (not represented), fixed by any appropriate means to this first end 30. The second end 31 of the second member 3 is coupled with the intermediate piece 4 by means of a second pivot connection allowing the relative swiveling of the second member 3 and the intermediate piece 4 about a second vertical axis A2. Thus, the relative swiveling of the first member 2, the second member 3 and the intermediate piece 4 is performed in the same plane, here an horizontal plane.

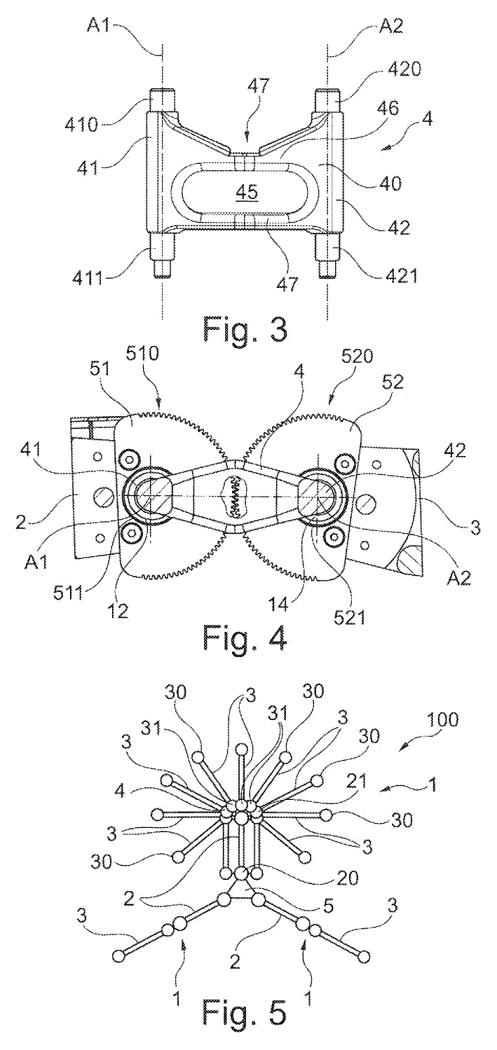

As it is represented in detail in FIG. 3, the intermediate piece 4 is monobloc. For example, it is made out of forged metal. It comprises a long central body 40, integral with a first shaft 41 and a second shaft 42, extending perpendicularly to the length of the central body 40 and parallel to one another. The ends of each first, second shaft 41, 42 extend in height, on both sides of the central body 40. The upper end of the first shaft 41 defines a first upper male bearing 410, cylindrical around the first axis A1. The lower end of the first shaft 41 defines a first lower male bearing 411, cylindrical around the first axis A1. The first upper and lower male bearings 410, 411 are thus coaxial with one another. In the illustrated example, they moreover have the same diameter. The first upper male bearing 410 receives the interior ring of a first upper rolling element 11. The first lower male bearing 411 receives the interior ring of a first lower rolling element 12. The upper end of the second shaft 42 defines a second upper male bearing 420, cylindrical around the second axis A2. The lower end of the second shaft 42 defines a second lower male bearing 421, cylindrical around the second axis A2. The second upper and lower male bearings 420, 421 are thus coaxial with one another. In the illustrated example, they have moreover the same diameter. The second upper male bearing 420 receives the interior ring of a second upper rolling element 13. The second lower male bearing 421 receives the interior ring of a second lower rolling element 14. The lower ends of the first and second shafts 41, 42 are each provided with a threaded opening 43 (represented in FIG. 1) able to receive an intermediate screw 44 for firmly fixing the intermediate piece 4 respectively to the first, second member 2, 3. When seen from above, the intermediate piece 4 has a rhombus shape whose vertices form the first and second shafts 41, 42. This shape imparts robustness and reliability to the intermediate piece 4.

In reference in particular to FIG. 3, the central body 40 is provided widthwise with an oblong opening 45 extending therethrough, whose length is oriented in the same direction as the length of the central body 40 between the first and second shafts 41, 42. The opening 45 thus defines an upper bar 46 delimiting its upper part and a lower bar 47 delimiting its lower part. This closed-outline opening 45 is able to allow the passage of a cable 6, for example an electric power supply cable or a signal transmission cable, extending from the first member 2 to the second member 3. In the case of an electric cable, this cable allows in particular the transmission of many “high frequency” signals such as video HD signals, data-processing signals. The closed outline of the opening 45 enables to prevent the cable 6 from going out of the opening 45. As the position of the cable 6 is controlled by the opening 45, the cable 6 cannot definitely be wedged when the first member 2, the second member 3 and the intermediate piece 4 swivel. The upper part of the upper bar 46 of the intermediate piece 4 has the shape of a V whose tip, oriented towards the opening 45, comprises a recess forming a fixing seat 47 able to receive the fixing tab 80 (represented in FIG. 1) of a central protective housing 8 described further below.

Each first, second member 2, 3 comprises respectively a first, second upper plate 22, 32 and a first, second lower plate 23, 33 parallel to one another in substantially horizontal planes. Each first, second upper plate 22, 32 of the first and second members 2, 3 comprises a first, second upper bore respectively defining a first, second female upper bearing 220, 320. The first and the second upper female bearings 220, 320 are cylindrical and respectively receive the external ring of the first and second upper rolling elements 11, 13 whose interior ring is supported by the upper end of the first, second shaft 41, 42 of the intermediate piece 4. The upper end of the first shaft 41 is thus guided around the first axis A1 with respect to the first member 2 by means of a first pivot connection. In the same way, the upper end of the second shaft 42 is thus guided around the second axis A2 with respect to the second member 3 by means of a second pivot connection. Thus, the second member 3 is able to swivel with respect to the intermediate piece 4, itself able to swivel in the same plane, here an horizontal plane, with respect to the first member 2.

The lower plates 23, 33 of the first and second members 2, 3 comprise each a first, second counterbore 231, 331 (represented in FIG. 1) housing a first, second crown 51, 52 respectively supporting a first, second toothed portion 510, 520. The first and second toothed portions 510, 520 are circular and coaxial respectively with the first, second axes A1, A2. As illustrated in FIG. 4, and in particular on the central zone in a partial sectional view, the first and second toothed portions 510, 520, thus arranged opposite one other, mesh with one other. Each first, second crown 51, 52 is integral respectively with the first, second lower plate 23, 33 via a crown screw 50. Each first, second crown 51, 52 comprises a first, second lower bore defining respectively a first, second female lower cylindrical bearing 511, 521, receiving respectively the external ring of the first, second lower rolling element 12, 14 whose corresponding internal ring is supported by the lower end of the first, second shaft 41, 42 of the intermediate piece 4. The lower end of the first shaft 41 is thus guided around the first axis A1 with respect to the first member 2 by means of the first pivot connection. In the same way, the lower end of the second shaft 42 is thus guided around the second axis A2 with respect to the second member 3 by means of the second pivot connection.

FIG. 5 illustrates an installation 100 for electrical appliances (not represented) such as for example a lighting equipment, a camera, a flat screen support, a monitor or any other appropriate equipment. This installation comprises a triangular support 5 supporting three articulated arms 1. The support can have any other appropriate shape and support a different number of arms. In this Figure, one of the articulated arms 1 is illustrated in eleven different swiveling positions of its first and second members 2, 3 and its intermediate piece 4. These positions are possible tanks to the first and second connections pivot having first and second axes A1, A2. In this FIG. 5, the two other articulated arms 1 are illustrated with their first and second members 2, 3 in alignment with one another. This FIG. 5 clearly shows that, thanks to the intermediate piece 4, the second member 3 can swivel over 360° between its two extreme positions, on both sides of the first member 2, while remaining in the same horizontal plane as the first member 2. Thus, the articulated arm 1 has a limited overall height. The swiveling over 360° is in particular possible thanks to the cumulated thickness of the half-widths of the first and second members 2, 3 which is at the most equal, and preferably inferior, to the center distance of the first and the second axis A1, A2.

In reference in particular to FIG. 1, the first, second lower and upper plates 22, 23, 32, 33 of each first and second member 2, 3 are moreover separated by cylindrical spacers 7 whose ends are fixed by spacer screws 70 extending through the lower and upper plates 22, 23, 32, 33. Moreover, the lower plates 23, 33 of the first and second members 2, 3 comprise a lower bore 233, 333 allowing the passage of the lower ends of the first and second shafts 41, 42. The head of the intermediate screw 44 and the outline of this lower bore 233, 333 are separated on the one hand by a stacking of lock washers 70 housed in a ring 71 and on the other hand by a lock disc 72 forming a friction means enabling to make a swiveling of the first member 2, the second member 3 and the intermediate piece 4 more fluid and regular. The lock disc 72 can be made out of any known appropriate material. According to an alternative embodiment not represented, the friction means can comprise a side friction finger tangential to one or more shaft ends and fulfilling the same function as the lock disc.

Each first, second arm 2, 3 is provided with a first, second protective housing 91, 92 enveloping each the ends of the first, second lower and upper plates 22, 23, 32, 33 respectively of the first, second member 2, 3. The first protective housing 91 is fixed to the first member 2 and the second protective housing 92 is fixed to the second member 3 while forming a sufficient space between the first and the second member 2, 3 for the first and second toothed portions 510, 520 to mesh with one another. For this purpose, the ends of the first and second protective housings 91, 92 are round so that that they cannot interfere with one other when the first, second members 2, 3 and the intermediate piece 4 swivel. Thus, at any time, the first and second lower rolling elements 12, 14 and the first and second upper rolling elements 11, 13 are protected by the first and second protective housings 91, 92, irrespective of the orientation of the first and second members 2, 3 and intermediate piece 4 with respect to one another.

The articulated arm 1 moreover comprises a central protective housing 8 supported by the intermediate piece 4. This central protective housing 8 has a first and a second shell 81, 82 respectively covering the first and second crowns 51, 52. The first and second shells 81, 82 are joined together by a fixing tab 80 received in the fixing seat 47 in the intermediate piece 4 in order to ensure the fixation of the central protective housing 8 to the intermediate piece 4, for example by means of a screw (not represented). Thus, at any time, the first and second crowns 51, 52 and in particular the first and second toothed portions 510, 520, are protected by the central protective housing 8, irrespective of the orientation of the first and second members 2, 3 with respect to one another.

In reference to FIG. 2, the second member 3 can be coupled with a third member 9, articulated about a third axis A3 allowing its swiveling in a vertical plane. This third member 9 is used as a compensation arm with respect to the first and second members used as extension arms. Thus, the electrical appliance supported by the free end of this third member 9 can be positioned in space, horizontally by means of the first and second members 2, 3 and vertically by means of the third member 9.

The invention makes it possible to achieve the objectives previously mentioned. Indeed, while presenting a limited overall height, the articulated arm 1 allows the swiveling of the second member 3 over an angle of 360° on both sides of the first member 2. Moreover, irrespective of the configuration of the first, second and third members 2, 3, 9, the cable 6 extending through the opening 45 in the intermediate piece 4 is protected against any early wear, it cannot be wedged between the moving pieces and in particular between the first and second toothed portions 510, 520, and adopts radii of curvature that are not detrimental to it.

Of course, the present invention is not limited to the preceding description of one of its embodiments which can be somewhat modified while remaining within the scope of the invention.

What is claimed is:

1. An articulated arm in particular for an electrical appliance, comprising at least first and second coplanar members separated by an intermediate piece to which each member is connected respectively by a first and a second pivot connection allowing their relative swiveling about first and second axes parallel to one another, said first and second members comprising respectively first and second circular toothed portions able to swivel about said first and second axes and arranged to mesh with one another, said articulated arm comprising a cable extending from said first member to said second member up to said electrical appliance, wherein said intermediate piece is monobloc and comprises a central body integral with a first and a second shaft defining said first and second axes, said first and second shafts being separated by a closed-outline opening through the central body, in that said cable extends through said opening in said monobloc intermediate piece so that said cable is kept away from said first and second toothed portions by the closed outline of said opening.

2. The articulated arm according to claim 1, wherein said opening has an oblong shape whose length is oriented from said first to said second axis, perpendicularly to said first and second axes.

3. The articulated arm according to claim 1, wherein the center distance between said first and second axes is at least equal to the sum of the half-widths of said first and second members so as to allow said second member to swivel with respect to said first member between two extreme positions separated by an angle of 360°.

4. The articulated arm according to claim 1, wherein each first, second member comprises respectively a pair of first and second female bearings, cylindrical and coaxial to one another, in that the ends of said first and second shafts are arranged so as to project on both sides of said central body and to define respectively first and second male bearings, cylindrical and coaxial to one another and able to cooperate with said female bearings in order to define said first and second axes.

5. The articulated arm according to claim 4, wherein said first toothed portion comprises one of said first female bearings and said second toothed portion comprises one of said second female bearings.

6. The articulated arm according to claim 4, wherein it comprises first and second rolling elements provided between each first, second male bearing and the corresponding first, second female cylindrical bearing.

7. The articulated arm according to claim 6, wherein it comprises a first protective housing integral with said first member and a second protective housing integral with said second housing, each first, second housing being arranged so as to surround said first and second rolling elements and to keep them away from the outside of said articulated arm.

8. The articulated arm according to claim 1, wherein it comprises a central protective housing integral with said intermediate piece and arranged so as to surround said first and second toothed portions and to keep them away from the outside of said articulated arm.

9. The articulated arm according to claim 1, wherein it comprises friction means provided between said intermediate piece and at least one of said first and second members, arranged so as to slow down the swiveling respectively of said first, second member with respect to said intermediate piece in order to make it fluid and regular.

10. An installation for an electrical appliance comprising a support supporting at least one articulated arm whose free end is provided with an electrical appliance, in particular a lighting equipment, connected by a cable, wherein the installation comprises an articulated arm according to claim 1.
